(19) United States
(12) Patent Application Publication
(10) Pub. No.: US 2010/0093915 A1
(43) Pub. Date: Apr. 15, 2010

(54) IMPACT-MODIFIED MOLDING COMPOSITION AND METHOD

(76) Inventors: Albin Peter Berzinis, Delmar, NY (US); Sandeep Dhawan, Newburgh, IN (US); Viswanathan Kalyanaraman, Athens, OH (US)

Correspondence Address: SABIC - CYCOLOY;SABIC Innovative Plastics - IP Legal, ONE PLASTICS AVENUE, PITTSFIELD, MA, 01201-3697, US

(21) Appl. No.: 12/469,437

(22) Filed: May 20, 2009

Related U.S. Application Data
(63) Continuation-in-part of application No. 11/138,551, filed on May 26, 2005.

(51) Int. Cl. C08L 51/04; C08F 255/00

(52) U.S. Cl. 524/523; 525/308; 525/84; 524/504

(57) ABSTRACT

A method is disclosed for preparing an acrylic-styrene-acrylonitrile (ASA) resin, which comprises the steps of: (a) polymerizing a mixture comprising at least one acrylate monomer and at least one polyethylenically unsaturated monomer to form a rubber substrate, followed by (b) polymerizing a mixture of monomers in the presence of the rubber substrate, at least one of which monomers is selected from the group consisting of vinyl aromatic monomers and at least one of which monomers is selected from the group consisting of monoethylenically unsaturated nitrile monomers, and optionally followed by (c) polymerizing one or more monomers in at least one subsequent stage in the presence of the rubber substrate from (b), wherein the one or more monomers comprise at least one monomer selected from the group consisting of (C₁-C₁₂)alkyl- and aryl-(meth)acrylate monomers; wherein the amount of unreacted polyethylenically unsaturated monomer remaining in the rubber substrate before step (b) is less than 5.6 micromoles per gram based on the dry weight of the rubber substrate. The invention also relates to a molding composition comprising an ASA resin comprising an elastomeric phase derived from a rubber substrate comprising structural units derived from at least one polyethylenically unsaturated monomer; wherein the rubber substrate comprises less than 5.6 micromoles of unreacted polyethylenically unsaturated monomer per gram of rubber substrate based on dry weight of the rubber substrate. Articles comprising said ASA resin and/or made from said molding composition are also disclosed.

### CROSS-REFERENCE TO RELATED APPLICATIONS

This application is a continuation-in-part of application Ser. No. 11/138,551, filed May 26, 2005, which is incorporated herein by reference.

### BACKGROUND

The present invention is directed to compositions comprising rubber modified thermoplastic resins and a method for preparing said compositions. In a particular embodiment the present invention is directed to compositions comprising an acrylic-styrene-acrylonitrile (ASA) resin comprising structural units derived from at least one vinyl aromatic monomer and at least one monoethylenically unsaturated nitrile monomer, and optionally, at least one monomer selected from the group consisting of (C₁-C₁₂)alkyl- and aryl-(meth)acrylate monomers.

For reasons of an excellent balance of impact strength, flow and chemical resistance a wide variety of commercial rubber-modified blends are based on styrene-acrylonitrile (SAN) copolymers. The widest commercial utility of such products is found when the rubber impact modifier phase is polybutadiene (PBD) to create the family of resins known as ABS. In order to improve the retention of impact strength and appearance upon outdoor exposure, styrene-acrylonitrile compositions comprising at least one alkyl acrylate, such as poly(butyl acrylate) (PBA) rubbers, are prepared, known as ASA (acrylic-styrene-acrylonitrile) resins. ASA resins further comprising structural units derived from methyl methacrylate exhibit improvement in color stability on exposure to real or simulated outdoor aging, and also excellent retention of surface gloss under the same conditions.

ASA compositions, however, are known to be sensitive to molding conditions. Higher melt and mold temperatures beneficially provide a higher gloss, lower haze and better surface color properties. Unfortunately, molding such compositions at higher temperature also increases the cycle time as the molded composition must reside in the mold cavity for a longer time for cooling before ejection. Thus, the number of parts produced per hour goes down, and the overall cost per molded part increases. Due to the cost increase, molders prefer to process such compositions at lower melt and mold temperatures which results in poor surface aesthetics in molded parts comprising ASA. Therefore, a problem to be solved is to devise an efficient method for retaining good surface aesthetics in molded parts comprising ASA while molding at low mold temperature to provide minimal loss in molding productivity.

### BRIEF DESCRIPTION

The present inventors have discovered a method for preparing molded parts comprising ASA with good surface aesthetics while preserving high productivity in the molding process. In a particular embodiment the present invention relates to a method for preparing an acrylic-styrene-acrylonitrile (ASA) resin comprising a discontinuous elastomeric phase dispersed in a rigid thermoplastic phase, wherein at least a portion of the rigid thermoplastic phase is grafted to the elastomeric phase, which comprises the steps of:

(a) polymerizing a mixture comprising at least one (C₁-C₁₂)alkyl(meth)acrylate monomer and at least one polyethylenically unsaturated monomer selected from the group consisting of diallyl maleate, diallyl fumarate, diallyl phthalate, triallyl isocyanurate and triallyl cyanurate to form a rubber substrate, wherein the total amount of polyethylenically unsaturated monomer is in a range of between about 0.3 wt. % and about 0.9 wt. %, based on the combined weight of polyethylenically unsaturated monomer and monoethylenically unsaturated alkyl (meth)acrylate monomer, wherein the polyethylenically unsaturated monomer is combined with the mixture in at least two separate steps, and wherein the amount of polyethylenically unsaturated monomer added to said reaction mixture in one or more steps following the first step is in a range of about 5 wt. % to about 30 wt. %, based on the total weight of polyethylenically unsaturated monomer employed, followed by

(b) polymerizing a mixture of monomers in the presence of the rubber substrate, at least one of which monomers is selected from the group consisting of vinyl aromatic monomers and at least one of which monomers is selected from the group consisting of monoethylenically unsaturated nitrile monomers, and optionally followed by

(c) polymerizing one or more monomers in at least one subsequent stage in the presence of the rubber substrate from (b), wherein the one or more monomers comprise at least one monomer selected from the group consisting of (C₁-C₁₂)alkyl- and aryl-(meth)acrylate monomers; wherein the amount of unreacted polyethylenically unsaturated monomer remaining in the rubber substrate before step (b) is less than 5.6 micromoles per gram based on the dry weight of the rubber substrate.

In another embodiment the present invention relates to a molding composition comprising an acrylic-styrene-acrylonitrile (ASA) resin comprising a discontinuous elastomeric phase dispersed in a rigid thermoplastic phase, wherein at least a portion of the rigid thermoplastic phase is grafted to the elastomeric phase; wherein the thermoplastic phase comprises structural units derived from at least one vinyl aromatic monomer, at least one monoethylenically unsaturated nitrile monomer, and optionally at least one (C₁-C₁₂)alkyl- and aryl-(meth)acrylate monomer; wherein the elastomeric phase is derived from a rubber substrate comprising structural units derived from at least one (C₁-C₁₂)alkyl(meth)acrylate monomer and at least one polyethylenically unsaturated monomer selected from the group consisting of diallyl maleate, diallyl fumarate, diallyl phthalate, triallyl isocyanurate and triallyl cyanurate; and wherein the rubber substrate comprises less than 5.6 micromoles of unreacted polyethylenically unsaturated monomer per gram of rubber substrate based on the dry weight of the rubber substrate before grafting. The present invention also relates to articles comprising said ASA resin and/or made from said molding composition. Various other features, aspects, and advantages of the present invention will become more apparent with reference to the following description and appended claims.

### DETAILED DESCRIPTION

In the following specification and the claims which follow, reference will be made to a number of terms which shall be defined to have the following meanings. The singular forms “a”, “an” and “the” include plural referents unless the context clearly dictates otherwise. The term acrylic-styrene-acrylonitrile (ASA) resin should be understood to comprise a resin comprising structural units derived from at least one vinyl aromatic monomer and at least one monoethylenically unsaturated nitrile monomer, and optionally, at least one monomer selected from the group consisting of (C₁-C₁₂)alkyl- and aryl-(meth)acrylate monomers.

In various embodiments compositions of the present invention comprise an acrylic-styrene-acrylonitrile (ASA) resin comprising a discontinuous elastomeric phase and a rigid thermoplastic phase wherein at least a portion of the rigid thermoplastic phase is grafted to the elastomeric phase. The ASA resin is synthesized by a method which employs at least one rubber substrate for grafting with monomers to form the rigid thermoplastic phase. The rubber substrate comprises the discontinuous elastomeric phase of the ASA resin. There is no particular limitation on the rubber substrate provided it comprises structural units derived from an acrylic monomer and is susceptible to grafting by at least a portion of a graftable monomer. The rubber substrate has a glass transition temperature, Tg, in one embodiment below about 0° C., in another embodiment below about minus 20° C., and in still another embodiment below about minus 30° C.

In various embodiments the rubber substrate is derived from polymerization by known methods of at least one monoethylenically unsaturated alkyl (meth)acrylate monomer selected from (C₁-C₁₂)alkyl(meth)acrylate monomers and mixtures comprising at least one of said monomers. As used herein, the terminology “monoethylenically unsaturated” means having a single site of ethylenic unsaturation per molecule, and the terminology “(meth)acrylate monomers” refers collectively to acrylate monomers and methacrylate monomers. As used herein, the terminology “(C_{X}-C_{y})”, as applied to a particular unit, such as, for example, a chemical compound or a chemical substituent group, means having a carbon atom content of from “x” carbon atoms to “y” carbon atoms per such unit. For example, “(C₁-C₁₂)alkyl” means a straight chain, branched or cyclic alkyl substituent group having from 1 to 12 carbon atoms per group and includes, but is not limited to, methyl, ethyl, n-propyl, iso-propyl, n-butyl, sec-butyl, t-butyl, pentyl, hexyl, heptyl, octyl, nonyl, decyl, undecyl and dodecyl. Suitable (C₁-C₁₂)alkyl(meth)acrylate monomers include, but are not limited to, (C₁-C₁₂)alkyl acrylate monomers, illustrative examples of which comprise ethyl acrylate, butyl acrylate, iso-pentyl acrylate, n-hexyl acrylate, and 2-ethyl hexyl acrylate; and their (C₁-C₁₂)alkyl methacrylate analogs illustrative examples of which comprise methyl methacrylate, ethyl methacrylate, propyl methacrylate, iso-propyl methacrylate, butyl methacrylate, hexyl methacrylate, and decyl methacrylate. In a particular embodiment of the present invention the rubber substrate comprises structural units derived from n-butyl acrylate.

In various embodiments the rubber substrate also comprises structural units derived from at least one polyethylenically unsaturated monomer, sometimes referred to hereinafter as “crosslinking agent”. As used herein, the terminology “polyethylenically unsaturated” means having two or more sites of ethylenic unsaturation per molecule. A polyethylenically unsaturated monomer is typically employed to provide crosslinking of the rubber particles and to provide “graftlinking” sites in the rubber substrate for subsequent reaction with grafting monomers. Suitable polyethylenic unsaturated monomers include, but are not limited to, butylene glycol diacrylate, divinyl benzene, butylene glycol dimethacrylate, trimethylolpropane tri(meth)acrylate, allyl methacrylate, diallyl methacrylate, diallyl maleate, diallyl fumarate, diallyl phthalate, triallyl methacrylate, triallyl cyanurate, triallyl isocyanurate, the acrylate of tricyclodecenylalcohol and mixtures comprising at least one of such monomers. In another particular embodiment the rubber substrate comprises structural units derived from triallyl cyanurate.

The present inventors have discovered that the presence of residual crosslinking agent in the rubber substrate before grafting with monomers to form the rigid thermoplastic phase results in unacceptable aesthetic appearance in molded parts comprising ASA resin. In particular the presence of excessive amounts of residual crosslinking agent in the rubber substrate, after it is prepared, often results in increased haze, lowered gloss and less intense color development upon addition of pigments or dyes in molded parts comprising ASA resin. In the present context residual crosslinking agent is unreacted and not bound to the rubber substrate as measured immediately after the rubber substrate's preparation and before any grafting process to create rigid thermoplastic phase. Thus, to alleviate unacceptable aesthetic effects in molded parts, the amount of residual crosslinking agent in the rubber substrate measured immediately after its preparation is in one embodiment less than about 5.6 micromoles per gram, in another embodiment less than about 4.0 micromoles per gram, in another embodiment less than about 3.2 micromoles per gram, in another embodiment less than about 2.0 micromoles per gram, and in still another embodiment less than about 1.2 micromoles per gram, based on the dry weight of rubber substrate used in preparing the ASA resin. In still another embodiment there is present less than about 4 micromoles reactive ethylenic functionality from residual crosslinking agent per gram of rubber substrate as measured immediately after rubber substrate preparation and based on the dry weight of rubber substrate used in preparing the ASA resin.

In some embodiments the rubber substrate may optionally comprise structural units derived from minor amounts of other unsaturated monomers, for example those that are copolymerizable with an alkyl (meth)acrylate monomer used to prepare the rubber substrate. Suitable copolymerizable monomers include, but are not limited to, C₁-C₁₂ aryl or haloaryl substituted acrylate, C₁-C₁₂ aryl or haloaryl substituted methacrylate, or mixtures thereof; monoethylenically unsaturated carboxylic acids, such as, for example, acrylic acid, methacrylic acid and itaconic acid; glycidyl (meth)acrylate, hydroxy alkyl (meth)acrylate, hydroxy(C₁-C₁₂)alkyl (meth)acrylate, such as, for example, hydroxyethyl methacrylate; (C₄-C₁₂)cycloalkyl (meth)acrylate monomers, such as, for example, cyclohexyl methacrylate; (meth)acrylamide monomers, such as, for example, acrylamide, methacrylamide and N-substituted-acrylamide or -methacrylamides; maleimide monomers, such as, for example, maleimide, N-alkyl maleimides, N-aryl maleimides and haloaryl substituted maleimides; maleic anhydride; vinyl methyl ether, vinyl esters, such as, for example, vinyl acetate and vinyl propionate. As used herein, the term “(meth)acrylamide” refers collectively to acrylamides and methacrylamides. Suitable copolymerizable monomers also include, but are not limited to, vinyl aromatic monomers, such as, for example, styrene and substituted styrenes having one or more alkyl, alkoxy, hydroxy or halo substituent groups attached to the aromatic ring, including, but not limited to, alpha-methyl styrene, p-methyl styrene, 3,5-diethylstyrene, 4-n-propylstyrene, vinyl toluene, alpha-methyl vinyltoluene, vinyl xylene, trimethyl styrene, butyl styrene, t-butyl styrene, chlorostyrene, alpha-chlorostyrene, dichlorostyrene, tetrachlorostyrene, bromostyrene, alpha-bromostyrene, dibromostyrene, p-hydroxystyrene, p-acetoxystyrene, methoxystyrene and vinyl-substituted condensed aromatic ring structures, such as, for example, vinyl naphthalene, vinyl anthracene, as well as mixtures of vinyl aromatic monomers and monoethylenically unsaturated nitrile monomers such as, for example, acrylonitrile, ethacrylonitrile, methacrylonitrile, alpha-bromoacrylonitrile and alpha-chloro acrylonitrile. Substituted styrenes with mixtures of substituents on the aromatic ring are also suitable

The rubber substrate may be present in the ASA resin in one embodiment at a level of from about 10 to about 94 percent by weight; in another embodiment at a level of from about 10 to about 80 percent by weight; in another embodiment at a level of from about 15 to about 80 percent by weight; in another embodiment at a level of from about 35 to about 80 percent by weight; in another embodiment at a level of from about 40 to about 80 percent by weight; in another embodiment at a level of from about 25 to about 60 percent by weight, and in still another embodiment at a level of from about 40 to about 50 percent by weight based on the total weight of the ASA resin. In other embodiments the rubber substrate may be present in the ASA resin at a level of from about 5 to about 50 percent by weight; at a level of from about 8 to about 40 percent by weight; or at a level of from about 10 to about 30 percent by weight based on the total weight of the ASA resin.

There is no particular limitation on the particle size distribution of the rubber substrate (as measured before any grafting process to create rigid thermoplastic phase and sometimes referred to hereinafter as initial rubber substrate to distinguish it from the rubber substrate following grafting). In some embodiments the rubber substrate may possess a broad particle size distribution with particles ranging in size from about 50 nanometers (nm) to about 1000 nm. In other embodiments the mean particle size by volume of the rubber substrate may be relatively narrow and have a mean value of less than about 150 nm. In still other embodiments the mean particle size by volume of the rubber substrate may be in a range of between about 80 nm and about 500 nm. In still other embodiments the mean particle size by volume of the rubber substrate may be relatively narrow and have a mean value in a range of between about 200 nm and about 750 nm. In other embodiments the mean particle size by volume of the rubber substrate may be greater than about 400 nm.

The ASA resin may be prepared by methods wherein monomers are polymerized in the presence of the rubber substrate to thereby form a graft copolymer, at least a portion of which is chemically grafted to the rubber phase. Any portion of graft copolymer not chemically grafted to rubber substrate comprises the rigid thermoplastic phase. The rigid thermoplastic phase comprises a thermoplastic polymer or copolymer that exhibits a glass transition temperature (Tg) in one embodiment of greater than about 25° C., in another embodiment of greater than or equal to 90° C., and in still another embodiment of greater than or equal to 100° C.

In a particular embodiment the rigid thermoplastic phase comprises a polymer having structural units derived from one or more monomers selected from the group consisting of (C₁-C₁₂)alkyl- and aryl-(meth)acrylate monomers, vinyl aromatic monomers and monoethylenically unsaturated nitrile monomers. Suitable (C₁-C₁₂)alkyl- and aryl-(meth)acrylate monomers, vinyl aromatic monomers and monoethylenically unsaturated nitrile monomers include those set forth hereinabove in the description of the rubber substrate. Examples of such polymers include, but are not limited to, a styrene/acrylonitrile copolymer, an alpha-methylstyrene/acrylonitrile copolymer, a styrene/methylmethacrylate copolymer, a styrene/maleic anhydride copolymer or an alpha-methylstyrene/styrene/acrylonitrile-, a styrene/acrylonitrile/methylmethacrylate-, a styrene/acrylonitrile/maleic anhydride- or a styrene/acrylonitrile/acrylic acid-terpolymer, or an alpha-methylstyrene/styrene/acrylonitrile terpolymer. These copolymers may be used for the rigid thermoplastic phase either individually or as mixtures.

In some embodiments the rigid thermoplastic phase comprises one or more vinyl aromatic polymers. Suitable vinyl aromatic polymers comprise at least about 20 wt. % structural units derived from one or more vinyl aromatic monomers. In a particular embodiment the rigid thermoplastic phase comprises a vinyl aromatic polymer having first structural units derived from one or more vinyl aromatic monomers and having second structural units derived from one or more monoethylenically unsaturated nitrile monomers. Examples of such vinyl aromatic polymers include, but are not limited to, a styrene/acrylonitrile copolymer, an alpha-methylstyrene/acrylonitrile copolymer, or an alpha-methylstyrene/styrene/acrylonitrile terpolymer. In another particular embodiment the rigid thermoplastic phase comprises a vinyl aromatic polymer having first structural units derived from one or more vinyl aromatic monomers; second structural units derived from one or more monoethylenically unsaturated nitrile monomers; and third structural units derived from one or more monomers selected from the group consisting of (C₁-C₁₂)alkyl- and aryl-(meth)acrylate monomers. Examples of such vinyl aromatic polymers include, but are not limited to, styrene/acrylonitrile/methyl methacrylate copolymer, styrene/alpha-methylstyrene/acrylonitrile/methyl methacrylate and alpha-methylstyrene/acrylonitrile/methyl methacrylate copolymer. These copolymers may be used for the rigid thermoplastic phase either individually or as mixtures.

When structural units in copolymers are derived from one or more monoethylenically unsaturated nitrile monomers, then the nitrile monomer content in the copolymer comprising the graft copolymer and the rigid thermoplastic phase may be in one embodiment in a range of between about 5 and about 40 percent by weight, in another embodiment in a range of between about 5 and about 30 percent by weight, in another embodiment in a range of between about 10 and about 30 percent by weight, and in yet another embodiment in a range of between about 15 and about 30 percent by weight, based on the weight of the copolymer comprising the graft copolymer and the rigid thermoplastic phase.

The amount of grafting that takes place between the rubber substrate and monomers comprising the rigid thermoplastic phase varies with the relative amount and composition of the rubber phase. In one embodiment, greater than about 10 wt % of the rigid thermoplastic phase is chemically grafted to the rubber, based on the total amount of rigid thermoplastic phase in the ASA resin. In another embodiment, greater than about 15 wt % of the rigid thermoplastic phase is chemically grafted to the rubber, based on the total amount of rigid thermoplastic phase in the ASA resin. In still another embodiment, greater than about 20 wt % of the rigid thermoplastic phase is chemically grafted to the rubber, based on the total amount of rigid thermoplastic phase in the ASA resin. In particular embodiments the amount of rigid thermoplastic phase chemically grafted to the rubber may be in a range of between about 5% and about 90 wt %; between about 10% and about 90 wt %; between about 15% and about 85 wt %; between about 15% and about 50 wt %; or between about 20% and about 50 wt %, based on the total amount of rigid thermoplastic phase in the ASA resin. In yet other embodiments, about 40 to 90 wt % of the rigid thermoplastic phase is free, that is, non-grafted.

The rigid thermoplastic phase may be present in the ASA resin in one embodiment at a level of from about 85 to about 6 percent by weight; in another embodiment at a level of from about 65 to about 6 percent by weight; in another embodiment at a level of from about 60 to about 20 percent by weight; in another embodiment at a level of from about 75 to about 25 percent by weight, in another embodiment at a level of from about 50 to about 30 percent by weight, and in still another embodiment at a level of from about 45 to about 35 percent by weight based on the total weight of the ASA resin. In other embodiments rigid thermoplastic phase may be present in the ASA resin in a range of between about 90% and about 30 wt %, based on the total weight of the ASA resin.

The rigid thermoplastic phase may be formed solely by polymerization carried out in the presence of rubber substrate or by addition of one or more separately polymerized rigid thermoplastic polymers to a rigid thermoplastic polymer that has been polymerized in the presence of the rubber substrate. When at least a portion of separately synthesized rigid thermoplastic phase is added, then the amount of said separately synthesized rigid thermoplastic phase added is in an amount in a range of between about 30 wt. % and about 80 wt. % based on the weight of the entire ASA resin. Two or more different rubber substrates each possessing a different mean particle size may be separately employed in such a polymerization reaction and then the products blended together. In illustrative embodiments wherein such products each possessing a different mean particle size of initial rubber substrate are blended together, then the ratios of said substrates may be in a range of about 90:10 to about 10:90, or in a range of about 80:20 to about 20:80, or in a range of about 70:30 to about 30:70. In some embodiments an initial rubber substrate with smaller particle size is the major component in such a blend containing more than one particle size of initial rubber substrate.

The rigid thermoplastic phase may be made according to known processes, for example, mass polymerization, emulsion polymerization, suspension polymerization or combinations thereof, wherein at least a portion of the rigid thermoplastic phase is chemically bonded, i.e., “grafted” to the rubber phase via reaction with unsaturated sites present in the rubber phase. The grafting reaction may be performed in a batch, continuous or semi-continuous process. Representative procedures include, but are not limited to, those taught in U.S. Pat. Nos. 3,944,631; and European Patent application 0913408B1. The unsaturated sites in the rubber phase are provided, for example, by residual unsaturated sites in those structural units of the rubber that were derived from a polyethylenically unsaturated monomer.

In some embodiments the ASA resin may be prepared by a method wherein monomer grafting to rubber substrate with concomitant formation of rigid thermoplastic phase is optionally performed in stages wherein at least one first monomer is grafted to rubber substrate followed by at least one second monomer different from said first monomer, as described, for example in U.S. Pat. No. 7,049,368. In the present context the change from one graft stage to the next is defined as that point where there is a change in the identity of at least one monomer added to the rubber substrate for grafting. In one embodiment formation of rigid thermoplastic phase and grafting to rubber substrate are performed by feeding at least one first monomer over time to a reaction mixture comprising rubber substrate. In this context a second graft stage occurs when a different monomer is introduced into the feed stream in the presence or absence of said first monomer.

When staged grafting is employed, at least two stages are employed for grafting, although additional stages may be employed. The first graft stage is performed with one or more monomers selected from the group consisting of vinyl aromatic monomers and monoethylenically unsaturated nitrile monomers. In a particular embodiment grafting is performed in a first stage with a mixture of monomers, at least one of which is selected from the group consisting of vinyl aromatic monomers and at least one of which is selected from the group consisting of monoethylenically unsaturated nitrile monomers. When at least one vinyl aromatic monomer and at least one monoethylenically unsaturated nitrile monomer are employed in the first graft stage, then the wt./wt. ratio of vinyl aromatic monomer to monoethylenically unsaturated nitrile monomer is in one embodiment in a range of between about 1:1 and about 6:1, in another embodiment in a range of between about 1.5:1 and about 4:1, in still another embodiment in a range of between about 2:1 and about 3:1, and in still another embodiment in a range of between about 2.5:1 and about 3:1. In one preferred embodiment the wt./wt. ratio of vinyl aromatic monomer to monoethylenically unsaturated nitrile monomer employed in the first graft stage is about 2.6:1.

When staged grafting is employed, then in at least one subsequent stage following said first stage, grafting is performed with one or more monomers selected from the group consisting of (C₁-C₁₂)alkyl- and aryl-(meth)acrylate monomers, vinyl aromatic monomers and monoethylenically unsaturated nitrile monomers. In a particular embodiment grafting is performed in at least one subsequent stage with one or more monomers, at least one of which is selected from the group consisting of (C₁-C₁₂)alkyl- and aryl-(meth)acrylate monomers. In another particular embodiment grafting is performed in at least one subsequent stage with a mixture of monomers, at least one of which is selected from the group consisting of (C₁-C₁₂)alkyl- and aryl-(meth)acrylate monomers and at least one of which is selected from the group consisting of vinyl aromatic monomers and monoethylenically unsaturated nitrile monomers. In another particular embodiment grafting is performed in at least one subsequent stage with a mixture of monomers, one of which is selected from the group consisting of (C₁-C₁₂)alkyl- and aryl-(meth)acrylate monomers; one of which is selected from the group consisting of vinyl aromatic monomers and one of which is selected from the group consisting of monoethylenically unsaturated nitrile monomers. Said(C₁-C₁₂)alkyl- and aryl-(meth)acrylate monomers, vinyl aromatic monomers and monoethylenically unsaturated nitrile monomers include those described hereinabove.

When staged grafting is employed, then in the first graft stage the amount of monomer employed for grafting to rubber substrate is in one embodiment in a range of between about 5 wt. % and about 98 wt. %; in another embodiment in a range of between about 5 wt. % and about 95 wt. %; in another embodiment in a range of between about 10 wt. % and about 90 wt. %; in another embodiment in a range of between about 15 wt. % and about 85 wt. %; in another embodiment in a range of between about 20 wt. % and about 80 wt. %; and in yet another embodiment in a range of between about 30 wt. % and about 70 wt. %, based on the total weight of monomer employed for grafting in all stages. In one particular embodiment the amount of monomer employed for grafting to rubber substrate in the first stage is in a range of between about 30 wt. % and about 95 wt. % based on the total weight of monomer employed for grafting in all stages. Further monomer is then grafted to rubber substrate in one or more stages following said first stage. In one particular embodiment all further monomer is grafted to rubber substrate in one second stage following said first stage.

When at least one (C₁-C₁₂)alkyl- and aryl-(meth)acrylate monomer is employed for grafting to rubber substrate in a stage following the first stage, then the amount of said (meth)acrylate monomer is in one embodiment in a range of between about 95 wt. % and about 2 wt. %; in another embodiment in a range of between about 80 wt. % and about 2 wt. %; in another embodiment in a range of between about 70 wt. % and about 2 wt. %; in another embodiment in a range of between about 50 wt. % and about 2 wt. %; in another embodiment in a range of between about 45 wt. % and about 2 wt. %; and in yet another embodiment in a range of between about 40 wt. % and about 5 wt. %, based on the total weight of monomer employed for grafting in all stages.

When a mixture of monomers comprising at least one (C₁-C₁₂)alkyl- and aryl-(meth)acrylate monomer is employed for grafting to rubber substrate in a stage following the first stage, then the wt./wt. ratio of said (meth)acrylate monomer to the totality of other monomers is in one embodiment in a range of between about 10:1 and about 1:10; in another embodiment in a range of between about 8:1 and about 1:8; in another embodiment in a range of between about 5:1 and about 1:5; in another embodiment in a range of between about 3:1 and about 1:3; in another embodiment in a range of between about 2:1 and about 1:2; and in yet another embodiment in a range of between about 1.5:1 and about 1:1.5.

In particular embodiments the ASA resin comprises a rigid thermoplastic phase comprising either a styrene/acrylonitrile copolymer or a styrene/acrylonitrile/methyl methacrylate copolymer. An ASA resin comprising a styrene/acrylonitrile/methyl methacrylate copolymer as rigid thermoplastic phase is sometimes referred to as a methyl methacrylate-modified ASA (sometimes abbreviated MMA-ASA). In another particular embodiment the rubber modified thermoplastic resin consists essentially of an ASA resin which is not modified with MMA. In another particular embodiment the rubber modified thermoplastic resin consists essentially of an MMA-ASA resin.

Compositions of the present invention further optionally comprise at least one other resin, illustrative examples of which include, but are not limited to, polycarbonates, polyesters, styrenic polymers and copolymers, poly(alpha-methyl styrene), SAN, ABS, poly(meth)acrylate polymers and copolymers; poly(methyl methacrylate); copolymers derived from at least one vinyl aromatic monomer, at least one monoethylenically unsaturated nitrile monomer, and at least one (meth)acrylate monomer; MMASAN copolymer; copolymers derived from at least one vinyl aromatic monomer, at least one monoethylenically unsaturated nitrile monomer, and at least one maleimide monomer; styrene/acrylonitrile/N-phenylmaleimide copolymer; copolymers derived from at least one vinyl aromatic monomer, at least one monoethylenically unsaturated nitrile monomer, and at least one maleic anhydride monomer; or styrene/acrylonitrile/maleic anhydride copolymer.

Compositions of the present invention may optionally comprise additives known in the art including, but not limited to, stabilizers, such as color stabilizers, heat stabilizers, light stabilizers, antioxidants, UV screeners, and UV absorbers; flame retardants, anti-drip agents, lubricants, flow promoters and other processing aids; plasticizers, antistatic agents, mold release agents, impact modifiers, fillers, and colorants such as dyes and pigments which may be organic, inorganic or organometallic; and like additives. Illustrative additives include, but are not limited to, silica, silicates, zeolites, titanium dioxide, stone powder, glass fibers or spheres, carbon fibers, carbon black, graphite, calcium carbonate, talc, mica, lithopone, zinc oxide, zirconium silicate, iron oxides, diatomaceous earth, calcium carbonate, magnesium oxide, chromic oxide, zirconium oxide, aluminum oxide, crushed quartz, clay, calcined clay, talc, kaolin, asbestos, cellulose, wood flour, cork, cotton and synthetic textile fibers, especially reinforcing fillers such as glass fibers, carbon fibers, and metal fibers. Often more than one additive is included in compositions of the invention, and in some embodiments more than one additive of one type is included. In a particular embodiment a composition further comprises an additive selected from the group consisting of colorants, dyes, pigments, lubricants, stabilizers, fillers and mixtures thereof.

The compositions of the present invention can be formed into useful articles. In some embodiments the articles are unitary articles comprising a composition of the present invention. In other embodiments the articles are multilayer articles comprising a layer comprising a composition of the invention. Illustrative examples of such multilayer and unitary articles include, but are not limited to, articles for outdoor vehicle and device (OVAD) applications; exterior and interior components for aircraft, automotive, truck, military vehicle (including automotive, aircraft, and water-borne vehicles), scooter, and motorcycle, including panels, quarter panels, rocker panels, vertical panels, horizontal panels, trim, pillars, center posts, fenders, doors, decklids, trunklids, hoods, bonnets, roofs, bumpers, fascia, grilles, mirror housings, pillar appliques, cladding, body side moldings, wheel covers, hubcaps, door handles, spoilers, window frames, headlamp bezels, tail lamp housings, tail lamp bezels, license plate enclosures, roof racks, and running boards; enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings, personal water-craft; jet-skis; pools; spas; hot-tubs; steps; step coverings; building and construction applications such as glazing, fencing, decking planks, roofs; siding, particularly vinyl siding applications; windows, floors, decorative window furnishings or treatments; wall panels, and doors; outdoor and indoor signs; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; articles made from plastic-wood combinations; golf course markers; utility pit covers; mobile phone housings; radio sender housings; radio receiver housings; light fixtures; lighting appliances; reflectors; network interface device housings; transformer housings; air conditioner housings; cladding or seating for public transportation; cladding or seating for trains, subways, or buses; meter housings; antenna housings; cladding for satellite dishes; and like applications.

Said articles may be prepared by a variety of known processes such as, for example, one or more steps of profile extrusion, sheet extrusion, coextrusion, extrusion blow molding and thermoforming, or injection molding. The invention further contemplates additional fabrication operations on said articles, such as, but not limited to, molding, in-mold decoration, baking in a paint oven, plating, or lamination. A particular and surprising advantage of the present invention is that it provides an efficient method for retaining good surface aesthetics in molded parts comprising ASA while molding at low mold temperature. Another advantage of the present invention is a method for improving productivity of molded parts comprising ASA through the use of lower mold temperatures. Typically, as the mold temperature is lowered, molded test parts comprising ASA comprising a rubber substrate wherein the amount of residual crosslinking agent in the rubber substrate immediately after its preparation is less than 5.6 micromoles per gram (based on the dry weight of the rubber substrate) in examples of the invention show either a higher gloss value or a lower haze value, or both a higher gloss value and a lower haze value compared to molded test parts of comparative examples comprising ASA comprising a rubber substrate wherein the amount of residual crosslinking agent in the rubber substrate immediately after its preparation is greater than 5.6 micromoles per gram. (based on the dry weight of the rubber substrate). Illustrative, non-limiting mold temperature ranges at which these effects are seen are in one embodiment in a range of between about 55° C. and about 75° C. and in another embodiment in a range of between about 60° C. and about 70° C.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

The general method by which the amount of residual crosslinking agent in the rubber substrate is minimized to a desired level comprises combining crosslinking agent in more than one step with a reaction mixture comprising all or a portion of other monomers from which the rubber substrate is derived. In typical embodiments the crosslinking agent is combined with said reaction mixture in at least two separate steps. The crosslinking agent may be combined with said reaction mixture using typical methods and in any convenient manner. In addition, the crosslinking agent may be combined with said reaction mixture either neat or as a mixture with one or more other reaction mixture components. In a particular embodiment the crosslinking agent may be combined with said reaction mixture in the form of a mixture with at least one monoethylenically unsaturated alkyl (meth)acrylate monomer, such as, but not limited to, n-butyl acrylate. When combined as a mixture with one or more other reaction mixture components, the amount of crosslinking agent in said mixture is typically in a range of about 1 wt. % to about 99 wt. %, more particularly in a range of about 5 wt. % to about 50 wt. %, and still more particularly in a range of about 8 wt. % to about 25 wt. %, based on the total weight of said mixture. The amount of crosslinking agent added in a first step to the reaction mixture comprising all or a portion of other monomers from which the rubber substrate is derived is typically in a range of about 50 wt. % to about 99 wt. %, more particularly in a range of about 70 wt. % to about 95 wt. %, and still more particularly in a range of about 80 wt. % to about 90 wt. %, based on the total weight of crosslinking agent that is employed. The amount of crosslinking agent added to said reaction mixture in one or more steps following the first step is typically in a range of about 1 wt. % to about 50 wt. %, more particularly in a range of about 5 wt. % to about 30 wt. %, and still more particularly in a range of about 10 wt. % to about 25 wt. %, based on the total weight of crosslinking agent that is employed. In typical embodiments at least about 90% of the total amount of crosslinking agent by weight is combined with the reaction mixture in the first step before remaining crosslinking agent is combined in the second or subsequent steps. The total amount of crosslinking agent employed to prepare rubber substrate is in one embodiment in a range of between about 0.1 wt. % and about 0.9 wt. % and in another embodiment in a range of between about 0.3 wt. % and about 0.9 wt. %, based on the combined weight of crosslinking agent and monoethylenically unsaturated alkyl (meth)acrylate monomer. The present inventors have surprisingly found that employing more than one addition step for combining an amount of crosslinking agent with other monomers results in significantly lower levels of residual crosslinking agent in the final rubber substrate product.

In the following examples and comparative examples unreacted residual triallyl cyanurate (TAC) crosslinker in poly(butyl acrylate) was measured by dispersing aqueous poly(butyl acrylate) latex in dimethyl sulfoxide along with an internal standard at room temperature, and analyzing a sample by gas chromatography, which method had a detection threshold of about 0.08 micromoles per gram.

### Example 1

Example 1 illustrates the preparation of a small-particle size MMA-ASA resin by an emulsion polymerization process.

Procedure 1A: Preparation of small-particle size poly(butyl acrylate) substrate latex: A stainless steel reactor equipped with a bladed turbine agitator was charged with 70 parts by weight (pbw) of demineralized water and 0.15 pbw of tetrasodium pyrophosphate. Agitation was begun and the reactor contents were heated to 60° C. while purging the reactor contents with nitrogen for one hour. After purging was complete, 0.33 pbw of sodium lauryl sulfate were added and agitated for 5 minutes; the nitrogen feed was changed from purging to blanketing.

The following feed streams were prepared for charging to the reactor: butyl acrylate (“BA monomer”) in two portions of 83 pbw and 9.22 pbw; two solutions of crosslinking agent comprising 0.70 pbw of triallyl cyanurate in 6.30 pbw butyl acrylate (“TAC solution #1”) and 0.078 pbw of triallyl cyanurate in 0.70 pbw butyl acrylate (“TAC solution #2”); an activator solution containing 0.132 pbw sodium formaldehyde sulfoxylate, 0.025 pbw of the monosodium salt of ethylenediaminetetraacetic acid (NaHEDTA), 0.005 pbw ferrous sulfate heptahydrate and 15 pbw water (“activator solution”); 0.120 pbw cumene hydroperoxide (CHP); 40.7 pbw of demineralized water (DMW); and a surfactant solution containing 2.70 pbw of sodium lauryl sulfate (SLS) in 24.3 pbw of demineralized water (“soap solution”).

To begin the reaction, 7.25% of the first BA monomer portion and TAC solution #1 were batch-charged to the reactor followed by 20% of the total activator solution while maintaining agitation. Then 6% of the total CHP charge was added to initiate polymerization, wherein an exothermic reaction was typically observed within one minute of the CHP addition.

Ten minutes after observation of the first exotherm was taken as time zero (T=0). The soap solution and remainder of the other feed streams were then fed according to the pump schedule in Table 1 from T=0 while maintaining the reaction at 60° C. The resulting monodisperse latex of poly(butyl acrylate) was analyzed by means of multi-angle light scattering using a Coulter LS230 particle size analyzer and determined to have a mean particle size by volume of 109 nm. The amount of unreacted TAC monomer in the rubber latex at the end of the reaction was determined by GC analysis to be 1.52 micromoles per gram on the basis of aqueous latex, or 3.73 micromoles per gram of unreacted TAC in the PBA dry polymer solids.

TABLE 1

| | % of total to | |
|---|---|---|
| Material | be pumped | Reaction Time |
| 1st BA portion | 92.5% | 0-80 min |
| 1st BA/TAC Solution | 92.5% | 0-80 min |
| DMW | 100% | 0-80 min |
| Activator Solution | 80% | 0-105 min |
| CHP | 92.5% | 0-105 min |
| 2nd BA portion | 100% | 80-105 min |
| 2nd BA/TAC Solution | 100% | 80-100 min |
| 1st Pumped DMW/SLS | 100% | 0-105 min |
| Solution | | |

Procedure 1B: Preparation of small-particle size MMA-ASA graft copolymer: The graft copolymer was made by the aqueous emulsion polymerization of styrene, acrylonitrile and MMA monomers in the presence of the poly(butyl acrylate) rubber latex particles made by procedure 1A. A stainless steel reactor with an agitator fitted with turbine blades was charged with 185 pbw water, and 45.0 pbw poly(butyl acrylate) rubber particles (in the form of an aqueous poly(butyl acrylate) rubber latex containing about 39 wt. % solids), and the contents of the reactor were heated to 60° C. The following feed charges were prepared: styrene in two portions of 21.96 and 9.8 pbw; acrylonitrile in two portions of 8.54 and 6.13 pbw; 8.58 pbw methyl methacrylate (MMA); 0.200 pbw cumene hydroperoxide; an activator solution containing 0.0026 pbw ferrous sulfate heptahydrate, 0.0128 pbw of the disodium salt of ethylenediaminetetraacetic acid (Na₂EDTA), 0.23 pbw sodium formaldehyde sulfoxylate (SFS) and 5 pbw water; and a soap solution containing 0.2 pbw SLS in 1.8 pbw demineralized water. These were each fed into the reactor at substantially uniform respective rates according to the schedule in Table 2:

TABLE 2

| Feed Time | | Feed stream | Temperature |
|---|---|---|---|
| 0-50 | min | Styrene #1 | 60° C. |
| 0-50 | min | Acrylonitrile #1 | 60° C. |
| 50-90 | min | Styrene #2 | 60° C. |
| 50-90 | min | Acrylonitrile #2 | 60° C. |
| 50-90 | min | MMA | 60° C. |
| 0-90 | min | Soap solution | 60° C. |
| 0-125 | min | CHP, Activator solution | Ramp to 71° C. |
| | | | after 90 minutes |
| 125-140 | min | All feeds off | 71° C. |
| Cool at 140 | min | Cooling to 49° C. | Drop batch at 49° C. |

After the batch was cooled, 0.35 pbw of a 1:1 mixture of hindered phenol and thioester emulsified with fatty acid soap was added with stirring. The reactor contents were then coagulated by the addition of 3 pbw calcium chloride per 100 pbw graft copolymer particles (dry basis) at a temperature of from 85° C. to 91° C. and then dried in a fluid bed dryer at an outlet air temperature of 74° C.

### Example 2

Example 2 illustrates the preparation of a large-particle size MMA-ASA resin by an emulsion polymerization process by following a seeded semi-batch polymerization process.

Procedure 2A: Preparation of poly(butyl acrylate) seed latex: The seed latex particles were produced by a continuous emulsion polymerization reaction according to the method described in EP 0913408B1 Example 1, using a monomer feed composition of 0.47 pbw of TAC and 99.53 pbw of butyl acrylate. The resulting latex polymer yielded a broad particle size distribution with a mean particle size by volume of 270 nm determined by means of the Spectronic 20 light scattering method disclosed in the reference.

Procedure 2B: Preparation of large-particle size poly(butyl acrylate) substrate latex: A stainless steel reactor equipped with a bladed turbine agitator was charged with 90 pbw of demineralized water and 0.15 pbw of tetrasodium pyrophosphate. Agitation was begun and the reactor contents were heated to 60° C. while purging the reactor contents with nitrogen for one hour. After purging was complete, 1.25 pbw of the poly(butyl acrylate) seed latex from procedure 2A were added and agitated for 5 minutes; the nitrogen feed was changed from purging to blanketing.

The following feed streams were prepared for charging to the reactor: butyl acrylate (“BA monomer”) in 2 portions of 85.75 and 9.4 pbw; two solutions of crosslinking agent comprising 0.30 pbw of triallyl cyanurate in 2.70 pbw butyl acrylate (“TAC solution #1”) and 0.06 pbw of triallyl cyanurate in 0.54 pbw butyl acrylate (“TAC solution #2”); an activator solution containing 0.132 pbw sodium formaldehyde sulfoxylate, 0.025 pbw of the monosodium salt of ethylenediaminetetraacetic acid (NaHEDTA), 0.005 pbw ferrous sulfate heptahydrate and 15 pbw water (“activator solution”); 0.120 pbw cumene hydroperoxide (CHP); 58 pbw of demineralized water (DMW); and two surfactant solutions containing 0.30 pbw of sodium lauryl sulfate (SLS) in 2.7 pbw of demineralized water (“soap solution #1”), and 0.50 pbw of sodium lauryl sulfate (SLS) in 4.5 pbw of demineralized water (soap solution #2″).

Once the reaction temperature was back to 60° C. after charging the seed latex prepared in 2A, 20% of the activator solution was batch charged to the reactor. Then all of the remaining monomer, soap and activator feeds to the reactor were started and fed according to the feed schedule shown in Table 3. After all feeds had been charged, the reaction was held at 60° C. with agitation for 30 minutes, then cooled to 49° C. before dropping the batch from the reactor.

The resulting monodisperse latex of poly(butyl acrylate) was analyzed by means of multi-angle light scattering using a Coulter LS230 particle size analyzer and determined to have a mean particle size by volume of 507 nm. The amount of unreacted TAC monomer in the latex was determined by GC analysis to be 1.24 micromoles per gram on the basis of aqueous latex, or 3.41 micromoles per gram of TAC in the PBA dry polymer solids.

TABLE 3

| | % of total to be | |
|---|---|---|
| Material | pumped | Reaction Time |
| 1st BA | 100% | 5-135 min |
| 1st BA/TAC Solution | 100% | 5-135 min |
| Activator Solution | 80% | 0-175 min |
| CHP | 100% | 0-175 min |
| 2nd BA | 100% | 135-175 min |
| 2nd BA/TAC Solution | 100% | 135-165 min |
| 1st Pumped DMW/SLS | 100% | 20-175 min |
| Solution | | |
| 2nd Pumped DMW/SLS | 100% | 175-205 min |
| Solution | | |
| DMW | 100% | 5-135 min |

Procedure 2C: Preparation of large-particle size MMA-ASA graft resin: The graft copolymer was made by the aqueous emulsion polymerization of styrene, acrylonitrile and MMA monomers in the presence of the poly(butyl acrylate) rubber latex particles made by procedure 2B while following the recipe and process described in Example 1 and isolating in the manner described in Example 1, except that 0.6 pbw of SLS in 5.4 pbw of demineralized water was used as the soap solution.

### Comparative Example 1

A small-particle size MMA-ASA graft copolymer was prepared by first preparing a small particle size poly(butyl acrylate) substrate polymer by the emulsion polymerization conditions as described in procedure 1A using a second BA portion of 4.0 pbw and a TAC #2 solution of 0.6 pbw of TAC in 5.4 pbw of BA, and then subjecting 45 pbw of the substrate polymer to the graft emulsion polymerization conditions described in procedure 1B. The monodisperse latex of small particle size poly(butyl acrylate) substrate polymer was analyzed by means of multi-angle light scattering using a Coulter LS230 particle size analyzer and determined to have a mean particle size by volume of 111 nm. The amount of unreacted TAC monomer in the rubber latex at the end of the reaction was determined by GC analysis to be 5.98 micromoles per gram on the basis of aqueous latex, or 14.8 micromoles per gram of unreacted TAC in the PBA dry polymer solids.

### Comparative Example 2

A large-particle size MMA-ASA graft copolymer was prepared by first preparing a large-particle size poly(butyl acrylate) substrate polymer by the emulsion polymerization conditions as described in procedure 2B using a second BA portion of 4.0 pbw and a TAC #2 solution of 0.6 pbw of TAC in 5.4 pbw of BA, and then subjecting 45 pbw of the poly(butyl acrylate) substrate polymer to the graft emulsion polymerization conditions as described in procedure 2C. The monodisperse latex of large-particle size poly(butyl acrylate) substrate polymer was analyzed by means of multi-angle light scattering using a Coulter LS230 particle size analyzer and determined to have a mean particle size by volume of 520 nm. The amount of unreacted TAC monomer in the rubber latex at the end of the reaction was determined by GC analysis to be 6.83 micromoles per gram on the basis of aqueous latex, or 18.5 micromoles per gram of unreacted TAC in the PBA dry polymer solids.

In the following examples and comparative examples the components of the formulations were as follows: (i) AMSAN, a copolymer comprising structural units derived from 70 weight % alpha-methyl styrene and 30 weight % acrylonitrile, and having a melt volume rate value of about 10 cubic centimeters per 10 minutes measured at 230° C. using a 3.8 kilogram weight according to ISO 1133; (ii) MMASAN, a copolymer comprising structural units derived from 40 weight % styrene, 25 weight % acrylonitrile, and 35 weight % methyl methacrylate and having a melt volume rate value of about 40 cubic centimeters per 10 minutes measured at 220° C. using a 10 kilogram weight according to ISO 1133; and (iii) MMA-ASA, a mixture of copolymers, one derived from a rubber substrate with mean particle size by volume of about 100 nm and another derived from a rubber substrate with mean particle size by volume of about 500 nm, and each comprising structural units derived from about 32 weight % styrene, about 15 weight % acrylonitrile, about 9 weight % methyl methacrylate, and 45 weight % butyl acrylate. Values for haze and gloss were measured in a BYK Gardner haze-gloss meter at a 20 degree angle according to ASTM D2457-03. Molded test specimens were subjected to color measurements in the CIE L*a*b* space using a MacBeth 7000 instrument for color measurement. Values for L* were measured with specular component excluded using measurement mode “DREOL” on the MacBeth instrument.

### Examples 3-4 and Comparative Examples 3-4

Compositions were formulated using the components in parts by weight shown in Table 4. In addition each composition further comprised 2 parts per hundred parts resin (phr) carbon black. Also each composition further comprised 1.5 phr stabilizers, and 1 phr lubricants, which are not believed to affect molded part aesthetics. Example 3 and comparative example 3 comprised 33 parts MMA-ASA derived from rubber substrate with mean particle size by volume of about 100 nm and 12 parts MMA-ASA derived from rubber substrate with mean particle size by volume of about 500 nm (45 parts total). Example 4 and comparative example 4 comprised 28.5 parts MMA-ASA derived from rubber substrate with mean particle size by volume of about 100 nm and 10 parts MMA-ASA derived from rubber substrate with mean particle size by volume of about 500 nm (38.5 parts total). MMA-ASA with high residual level of TAC comprised a 75/25 blend of the products of comparative examples 1 and 2, respectively, and had greater than 5.6 micromoles per gram TAC based on dry weight of poly(butyl acrylate) measured immediately after the rubber substrate's preparation. MMA-ASA with low residual level of TAC comprised a 75/25 blend of the products of examples 1 and 2, respectively, had less than 5.6 micromoles per gram TAC based on dry weight of poly(butyl acrylate) measured immediately after the rubber substrate's preparation. The abbreviations “C.Ex.” and “Ex.” mean comparative example and example, respectively.

TABLE 4

| Component | C. Ex. 3 | Ex. 3 | C. Ex. 4 | Ex. 4 |
|---|---|---|---|---|
| AMSAN | 40 | 40 | — | — |
| MMASAN | 15 | 15 | 61.5 | 61.5 |
| MMA-ASA; | 45 | — | 38.5 | — |
| high residual TAC | | | | |
| MMA-ASA; | — | 45 | — | 38.5 |
| low residual TAC | | | | |
| Haze | | | | |
| 60° C. mold temp. | 111 | 52 | 52 | 36 |
| 71° C. mold temp. | 40 | 26 | 18 | 14 |
| 82° C. mold temp. | 17 | 15 | 12 | 12 |
| Gloss | | | | |
| 60° C. mold temp. | 73 | 84 | 80 | 83 |
| 71° C. mold temp. | 84 | 89 | 86 | 88 |
| 82° C. mold temp. | 89 | 92 | 88 | 89 |
| L* value | | | | |
| 60° C. mold temp. | 8.65 | 6.77 | 7.27 | 6.47 |
| 71° C. mold temp. | 6.35 | 5.58 | 5.92 | 5.37 |
| 82° C. mold temp. | 5.36 | 5.12 | 5.57 | 5.39 |

The properties of molded test parts show that compositions of the examples of the invention provide higher gloss values and lower haze values than compositions of the comparative examples, and particularly as the molding temperature is lowered for both compositions. Typically desired properties for molded parts include minimum haze with values of about 26 or less being particularly desired. The data also show that the examples of the invention provide lower L* values, and, hence, better color properties than the comparative examples, and particularly as the molding temperature is lowered for both compositions. Typically desired properties for molded parts include a minimum L* value, with values of about 6 or less being particularly desired in certain embodiments such as those involving carbon black pigmented parts.

### Example 5 and Comparative Example 5

A composition is prepared similar to that of example 3 except that the ASA resin is not modified with MMA and comprises a rubber substrate wherein the amount residual crosslinking agent in the rubber substrate immediately after its preparation is less than 5.6 micromoles per gram. A comparative composition is also prepared similar to those of comparative example 3 except that the ASA resin is not modified with MMA and comprises a rubber substrate wherein the amount residual crosslinking agent in the rubber substrate immediately after its preparation is greater than 5.6 micromoles per gram. Molded test parts show that the composition of the example of the invention provides either a higher gloss value or a lower haze value, or both a higher gloss value and a lower haze value compared to the composition of the comparative example, and in a particular embodiment said effects are seen as the molding temperature is lowered for both compositions.

### Example 6 and Comparative Example 6

A composition is prepared similar to that of example 4 except that the ASA resin is not modified with MMA and comprises a rubber substrate wherein the amount residual crosslinking agent in the rubber substrate immediately after its preparation is less than 5.6 micromoles per gram. A comparative composition is also prepared similar to those of comparative example 4 except that the ASA resin is not modified with MMA and comprises a rubber substrate wherein the amount residual crosslinking agent in the rubber substrate immediately after its preparation is greater than 5.6 micromoles per gram. Molded test parts show that the composition of the example of the invention provides either a higher gloss value or a lower haze value, or both a higher gloss value and a lower haze value compared to the composition of the comparative example, and in a particular embodiment said effects are seen as the molding temperature is lowered for both compositions.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All patents and patent applications cited herein are incorporated herein by reference.

1. A method for preparing an acrylic-styrene-acrylonitrile (ASA) resin comprising a discontinuous elastomeric phase dispersed in a rigid thermoplastic phase, wherein at least a portion of the rigid thermoplastic phase is grafted to the elastomeric phase, which comprises the steps of:
(a) polymerizing a mixture comprising at least one (C₁-C₁₂)alkyl(meth)acrylate monomer and at least one polyethylenically unsaturated monomer selected from the group consisting of diallyl maleate, diallyl fumarate, diallyl phthalate, triallyl isocyanurate and triallyl cyanurate to form a rubber substrate, wherein the total amount of polyethylenically unsaturated monomer is in a range of between about 0.3 wt. % and about 0.9 wt. %, based on the combined weight of polyethylenically unsaturated monomer and monoethylenically unsaturated alkyl (meth)acrylate monomer, wherein the polyethylenically unsaturated monomer is combined with the mixture in at least two separate steps, and wherein the amount of polyethylenically unsaturated monomer added to said reaction mixture in one or more steps following the first step is in a range of about 5 wt. % to about 30 wt. %, based on the total weight of polyethylenically unsaturated monomer employed, followed by
(b) polymerizing a mixture of monomers in the presence of the rubber substrate, at least one of which monomers is selected from the group consisting of vinyl aromatic monomers and at least one of which monomers is selected from the group consisting of monoethylenically unsaturated nitrile monomers, and optionally followed by
(c) polymerizing one or more monomers in at least one subsequent stage in the presence of the rubber substrate from (b), wherein the one or more monomers comprise at least one monomer selected from the group consisting of (C₁-C₁₂)alkyl- and aryl-(meth)acrylate monomers;
wherein the amount of unreacted polyethylenically unsaturated monomer remaining in the rubber substrate before step (b) is less than 5.6 micromoles per gram based on the dry weight of the rubber substrate.

2. The method of claim 1, wherein the rubber substrate comprises a polymer having structural units derived from butyl acrylate.

3. The method of claim 1, wherein the elastomeric phase initially comprises a rubber substrate with particles selected from the group consisting of a mixture of particles sizes with at least two mean particle size distributions and a broad size distribution having particles ranging in size from about 50 nm to about 1000 nm.

4. The method of claim 3, wherein the elastomeric phase initially comprises a rubber substrate with two mean particle size distributions by volume each in a range of between about 80 nm and about 500 nm.

5. The method of claim 1, wherein the rigid thermoplastic phase comprises about 50 to about 30 percent by weight, based on the total weight of the ASA resin.

6. The method of claim 1, wherein the mixture of monomers in step (b) comprises styrene and acrylonitrile, or alpha-methyl styrene and acrylonitrile or a mixture of styrene, alpha-methyl styrene and acrylonitrile.

7. The method of claim 6, wherein the wt./wt. ratio of styrene, alpha-methyl styrene or mixture thereof to acrylonitrile is in a range of between about 1.5:1 and about 4:1.

8. The method of claim 1, comprising step (c).

9. The method of claim 8, wherein the (C₁-C₁₂)alkyl- and aryl-(meth)acrylate monomer comprises methyl methacrylate.

10. The method of claim 8, wherein the monomer is a mixture further comprising at least one vinyl aromatic monomer.

11. The method of claim 9, wherein the monomer is a mixture further comprising at least one vinyl aromatic monomer and at least one monoethylenically unsaturated nitrile monomer.

12. The method of claim 9, wherein the wt./wt. ratio of methyl methacrylate to the total of vinyl aromatic monomer and monoethylenically unsaturated nitrile monomer is in a range of between about 3:1 and about 1:3.

13. The method of claim 9, wherein the monomer is a mixture further comprising styrene and acrylonitrile.

14. The method of claim 1, further comprising the step of combining the ASA resin with rigid thermoplastic phase prepared in a separate polymerization step.

15. The method of claim 14, wherein the rigid thermoplastic phase is a styrene-acrylonitrile copolymer.

16. The method of claim 14, wherein the rigid thermoplastic phase is a styrene-acrylonitrile-methyl methacrylate copolymer.

17. The method of claim 14, wherein the rigid thermoplastic phase separately prepared is combined at a level of between about 30 wt. % and about 80 wt. %, based on the weight of the ASA resin.

18. The method of claim 1, wherein the amount of unreacted polyethylenically unsaturated monomer remaining in the rubber substrate is less than 4.0 micromoles per gram based on the dry weight of the rubber substrate.

19. An acrylic-styrene-acrylonitrile resin made by the method of claim 1.

20. An article comprising the acrylic-styrene-acrylonitrile resin of claim 19.

21. An acrylic-styrene-acrylonitrile resin made by the method of claim 8.

22. An article comprising the acrylic-styrene-acrylonitrile resin of claim 21.

23. A method for preparing a methyl methacrylate-modified acrylic/styrene/acrylonitrile resin comprising about 35 to about 80 wt. % based on the total weight of the resin of a discontinuous elastomeric phase dispersed in a rigid thermoplastic phase, wherein at least a portion of the rigid thermoplastic phase is grafted to the elastomeric phase, which comprises the steps of:
(a) polymerizing a mixture consisting essentially of butyl acrylate and triallyl isocyanurate to form a rubber substrate, wherein the total amount of triallyl isocyanurate is in a range of between about 0.3 wt. % and about 0.9 wt. %, based on the combined weight of triallyl isocyanurate and butyl acrylate, wherein triallyl isocyanurate is combined with the mixture in at least two separate steps, and wherein the amount of triallyl isocyanurate added to said mixture in one or more steps following the first step is in a range of about 5 wt. % to about 30 wt. %, based on the total weight of triallyl isocyanurate employed, followed by
(b) polymerizing in a first stage in the presence of the rubber substrate, a monomer mixture of styrene and acrylonitrile in a wt./wt. ratio in a range of between about 2:1 and about 3:1;
(c) polymerizing in a second stage in the presence of the rubber substrate from (b), a mixture of styrene, acrylonitrile and methyl methacrylate, wherein styrene and acrylonitrile are employed in a wt./wt. ratio in a range of between about 1.5:1 and about 4:1, and the wt./wt. ratio of methyl methacrylate to the total of styrene and acrylonitrile is in a range of between about 3:1 and about 1:3,
wherein the amount of unreacted triallyl isocyanurate remaining in the rubber substrate before step (b) is less than 5.6 micromoles per gram based on the dry weight of the rubber substrate.

24. The method of claim 23, further comprising the step of combining the ASA resin with rigid thermoplastic phase selected from the group consisting of styrene-acrylonitrile copolymer and styrene-acrylonitrile-methyl methacrylate copolymer prepared in a separate polymerization step.

25. The method of claim 24, wherein the rigid thermoplastic phase separately prepared is combined at a level of between about 30 wt. % and about 80 wt. % based on the weight of the ASA resin.

26. A molding composition comprising an acrylic-styrene-acrylonitrile (ASA) resin comprising a discontinuous elastomeric phase dispersed in a rigid thermoplastic phase, wherein at least a portion of the rigid thermoplastic phase is grafted to the elastomeric phase; wherein the thermoplastic phase comprises structural units derived from at least one vinyl aromatic monomer, at least one monoethylenically unsaturated nitrile monomer, and optionally at least one (C₁-C₁₂)alkyl- and aryl-(meth)acrylate monomer; wherein the elastomeric phase is derived from a rubber substrate comprising structural units derived from at least one (C₁-C₁₂)alkyl(meth)acrylate monomer and at least one polyethylenically unsaturated monomer selected from the group consisting of diallyl maleate, diallyl fumarate, diallyl phthalate, triallyl isocyanurate and triallyl cyanurate; and wherein the rubber substrate comprises less than 5.6 micromoles of unreacted polyethylenically unsaturated monomer per gram of rubber substrate based on the dry weight of the rubber substrate before grafting.

27. The molding composition of claim 26, wherein the rubber substrate comprises a polymer having structural units derived from butyl acrylate.

28. The molding composition of claim 26, wherein the rigid thermoplastic phase comprises at least one material selected from the group consisting of styrene-acrylonitrile copolymer and styrene-acrylonitrile-methyl methacrylate copolymer.

29. The molding composition of claim 26, wherein the amount of unreacted polyethylenically unsaturated monomer remaining in the rubber substrate represents less than about 4 micromoles reactive ethylenic functionality per gram of rubber substrate, based on the dry weight of rubber substrate before grafting.

30. The molding composition of claim 26, further comprising at least one resin selected from the group consisting of polycarbonates, polyesters, styrenic polymers and copolymers, poly(alpha-methyl styrene), SAN, ABS, poly(meth)acrylate polymers and copolymers; poly(methyl methacrylate); copolymers derived from at least one vinyl aromatic monomer, at least one monoethylenically unsaturated nitrile monomer, and at least one (meth)acrylate monomer; MMASAN copolymer; copolymers derived from at least one vinyl aromatic monomer, at least one monoethylenically unsaturated nitrile monomer, and at least one maleimide monomer; styrene/acrylonitrile/N-phenylmaleimide copolymer; copolymers derived from at least one vinyl aromatic monomer, at least one monoethylenically unsaturated nitrile monomer, and at least one maleic anhydride monomer; and styrene/acrylonitrile/maleic anhydride copolymer.

31. The molding composition of claim 26, further comprising an additive selected from the group consisting of colorants, dyes, pigments, lubricants, stabilizers, fillers and mixtures thereof.

32. A molded article prepared from the composition of claim 26, having either a lower value for haze or a higher value for gloss as measured according to ASTM D2457-03 when compared to the values obtained for a molded article comprising the same composition except derived from a rubber substrate comprising greater than 5.6 micromoles per gram unreacted polyethylenically unsaturated monomer, based on the dry weight of the rubber substrate before grafting.

33. A molded article prepared from the composition of claim 30, having either a lower value for haze or a higher value for gloss as measured according to ASTM D2457-03 when compared to the values obtained for a molded article comprising the same composition except derived from a rubber substrate comprising greater than 5.6 micromoles per gram unreacted polyethylenically unsaturated monomer, based on the dry weight of the rubber substrate before grafting.
